(19) United States
(12) Patent Application Publication
(10) Pub. No.: US 2025/0303972 A1
(43) Pub. Date: Oct. 2, 2025

(54) BUTTONLESS LATCHING SYSTEM FOR VEHICLE ARMREST

(71) Applicant: GM GLOBAL TECHNOLOGY OPERATIONS LLC, Detroit, MI (US)

(72) Inventors: Jason C. BONE, Clarkston, MI (US); Timothy A. KIESTER, Lake Orion, MI (US)

(21) Appl. No.: 18/617,642

(22) Filed: Mar. 26, 2024

(51) Int. Cl. B60R 7/04; B60N 2/75

(52) U.S. Cl. CPC B60R 7/04; B60N 2/793

(57) ABSTRACT

A buttonless latching assembly keeps a spring assisted armrest closed due to the relative shape and interaction of a set of pawls and allows the armrest to be opened simply by pulling up on the armrest without the need for a user actuated release button. An internal inertia locking device prevent the lid from being opened when the vehicle experiences upward acceleration.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a buttonless latching system for a vehicle armrest.

Previous armrests have typically required a button or paddle to release the latch system to allow the armrest/console cover to be opened. The requirement of a button or paddle limits the armrest surface design.

### SUMMARY

A buttonless latching system with integrated inertia lock allows the armrest/lid to be latched in the closed position. The armrest/lid can be opened by a user without the need to operate a physical button or a paddle latch. Merely pulling upwards on the armrest allows the armrest/lid to be opened with or without a spring assist while still meeting federal safety regulations.

According to an aspect of the present disclosure, a vehicle compartment includes a compartment having two opposing side edges. A lid pivotally connected along one of the two opposing side edges of the compartment. A latch assembly disposed along a second one of the two opposing side edges and including a latch member biased by a spring toward a latched position and movable to an unlatched position. A finger is attached to the lid and adapted to engage the latch member, the finger includes a first cammed engagement surface and a second cammed engagement surface and the latch member including a third cammed engagement surface and a fourth cammed engagement surface, wherein the first cammed engagement surface engages the third cammed engagement surface when the lid is moved from an open position to a closed position and the second cammed engagement surface is engaged with the fourth cammed engagement surface when the lid is moved from the closed position to the open position. An inertia member responsive to a vertical acceleration to prevent the latch member from moving to the unlatched position.

According to a further aspect, the compartment is a vehicle console compartment.

According to a further aspect, the lid is an armrest.

According to a further aspect, the compartment is a glove compartment.

According to a further aspect, the latch assembly includes a track slidably supporting the latch member.

According to a further aspect, the spring is disposed between the latch member and the track.

According to a further aspect, the inertia member is rotatably supported adjacent to the track.

According to a further aspect, the latch member includes a pawl that includes the third cammed engagement surface and the fourth cammed engagement surface.

According to a further aspect, when the lid is moved from the open position to the closed position, the first cammed engagement surface engages the third cammed engagement surface and causes the latch member to move against a biasing force of the spring.

According to a further aspect, when the lid is moved from the closed position to the open position, the second cammed engagement surface engages the fourth cammed engagement surface and causes the latch member to move against a biasing force of the spring.

According to an aspect of the present disclosure, a vehicle compartment includes a compartment having two opposing side edges. A lid is pivotally connected along one of the two opposing side edges of the compartment. A latch assembly disposed along a second one of the two opposing side edges and including a pawl biased by a spring toward a latched position and movable to an unlatched position. A finger attached to the lid and adapted to engage the pawl, the finger including a first cam engagement surface and a second cam engagement surface and the pawl including a third cam engagement surface and a fourth cam engagement surface, wherein the first cam engagement surface engages the third cam engagement surface when the lid is moved from an open position to a closed position and the second cam engagement surface is engaged with the fourth cam engagement surface when the lid is moved from the closed position to the open position. An inertia member responsive to a vertical acceleration to prevent the pawl from moving to the unlatched position.

According to a further aspect, the latch assembly includes a support structure pivotally supporting the pawl.

According to a further aspect, the latch assembly includes two pawls pivotally supported by the support structure and the spring is disposed between the two pawls.

According to a further aspect, the inertia member is rotatably supported adjacent to the pawl.

According to a further aspect, the inertia member is rotatably supported by the support structure.

According to a further aspect, when the lid is moved from the open position to the closed position, the first cam engagement surface engages the third cam engagement surface and causes the pawl to move against a biasing force of the spring.

According to a further aspect, when the lid is moved from the closed position to the open position, the second cam engagement surface engages the fourth cam engagement surface and causes the pawl to move against a biasing force of the spring.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of a buttonless latching system for a vehicle armrest according to the principles of the present disclosure;

FIG. 2 is an exploded perspective view of a vehicle console compartment having the armrest and buttonless latching system according to the principles of the present disclosure;

FIG. 3 is a side view of an alternative buttonless latching system for a vehicle armrest according to the principles of the present disclosure; and

FIG. 4 is an exploded perspective view of a vehicle console compartment having the armrest and the alternative buttonless latching system according to the principles of the present disclosure.

In the drawings, reference numbers may be reused to identify similar and/or identical elements.

### DETAILED DESCRIPTION

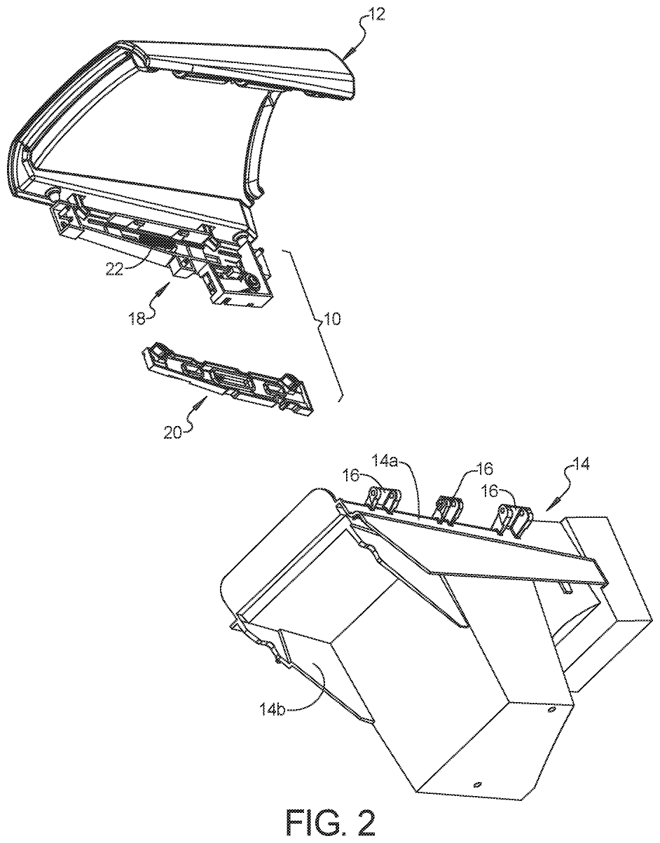

With reference to FIG. 2, a buttonless latch assembly 10 is provided for an armrest/lid 12 of a vehicle console 14. The armrest/lid 12 is connected to a first sidewall 14a of the vehicle console 14 by one or more hinges 16.

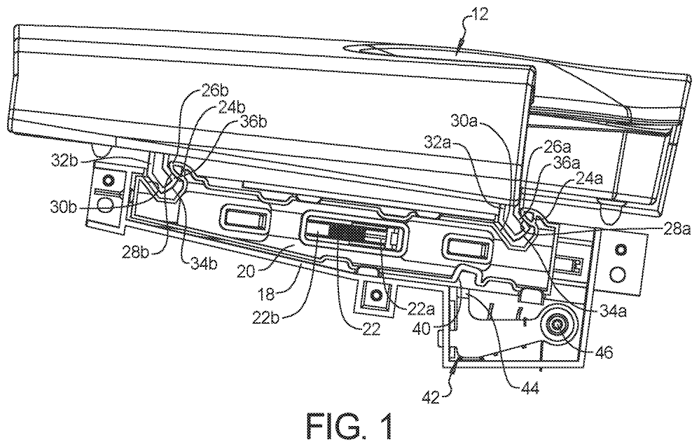

The buttonless latch assembly 10 is disposed along a second opposing sidewall 14b of the console 14. With reference to FIG. 1, the buttonless latch assembly 10 includes a track/support structure 18 that slidably supports a latch member 20. The latch member 20 is biased toward a latched position by a spring 22 that engages the track 18 at one end 22a and the latch member 20 at a second end 22b. The latch member 20 is movable to an unlatched position against the spring force of the spring 22. The latch member 20 includes a pair of pawls 24a, 24b each including a first pair of receiving cam engagement surfaces 26a, 26b and a second pair of retaining cam engagement surfaces 28a, 28b. The pair of pawls 24a, 24b are arranged at an opening to a respective pair of slots 30a, 30b.

A pair of latching fingers 32a, 32b are attached to the lid and adapted to engage the latch member 20. The pair of latching fingers 32a, 32b each include a distal cam engagement surface 34a, 34b and a proximal cam engagement surface 36a, 36b, respectively. The distal cam engagement surfaces 34a, 34b engage the receiving cam engagement surfaces 26a, 26b when the lid is moved from an open position to a closed position. The camming engagement causes the latch member 20 to move rightward as viewed in FIG. 1 to allow the latching fingers 32a, 32b to be received in the pair of slots 30a, 30b and the latch member 20 is biased leftward, as viewed in FIG. 1, to secure the lid 12 in a closed position.

The proximal cam engagement surfaces 36a, 36b are engaged with the retaining cam engagement surfaces 28a, 28b of the latch member 20 when the lid 12 is moved from the closed position to the open position. As the proximal cam engagement surfaces 36a, 36b are engaged with the retaining cam engagement surfaces 28a, 28b when the lid 12 is lifted upward, the latch member 20 is moved against the biasing force of the spring to allow the retaining cam engagement surfaces 28a, 28b to move rightward in FIG. 1, as viewed, and to allow the lid 12 to be opened.

As shown in FIG. 1, the latch member 20 further includes a notch 40 in a lower surface thereof. An inertia member 42 is pivotally mounted to the support structure 18 below the latch member 20 by a pivot 46. The inertia member 42 includes a finger 44 that is engageable with the notch 40 in the latch member 20. The inertia member 42 is responsive to a vertical acceleration to cause the inertia member 42 to pivot upward so that the finger engages the notch 40 in the latch member 20 and to prevent the latch member 20 from moving to the unlatched position.

The above described latch member 20 includes a pair of pawls 24a, 24b and a pair of latching fingers 32a, 32b. However, it should be noted that any number of pawls and latching fingers including one or more can be used. It is further noted that the lid 12 could be used on other compartments such as a glovebox.

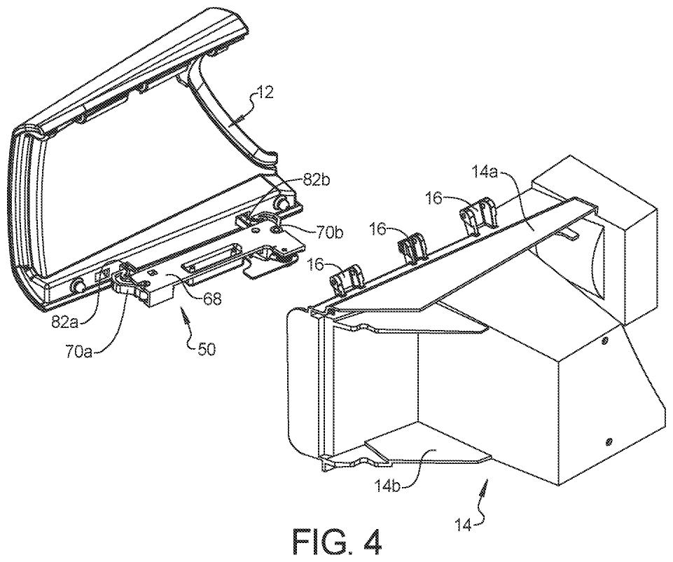

With reference to FIG. 4, a buttonless latch assembly 50 is provided for an armrest/lid 12 of a vehicle console 14. The armrest/lid 12 is connected to a first sidewall 14a of the vehicle console 14 by one or more hinges 16.

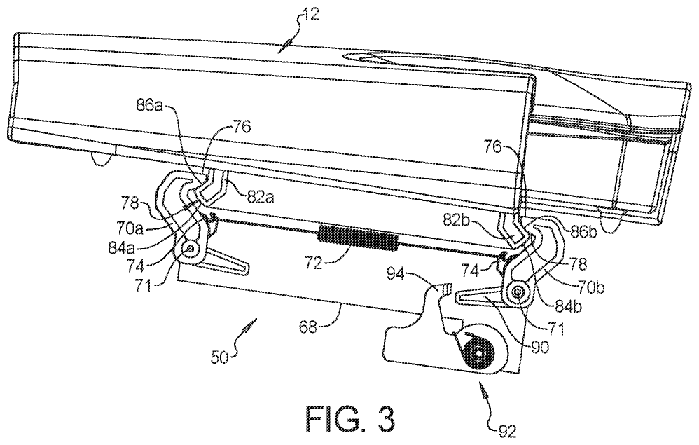

The buttonless latch assembly 50 is disposed along a second opposing sidewall 14b of the console 14. With reference to FIG. 3, the buttonless latch assembly 50 includes a support structure 68 that rotatably supports a pair of pawls 70a, 70b about corresponding pivots 71. The pawls 70a, 70b are each biased toward a latched position by a spring 72 that pulls the pawls 70a, 70b toward one another. The pawls 70a, 70b are movable to an unlatched position against the spring force of the spring 72. The pawls 70a, 70b each include a spring hook 74 that engage opposite ends of the spring 72. Each pawl 70a, 70b includes a first receiving cam engagement surface 76 and a second retaining cam engagement surface 78.

A pair of latching fingers 82a, 82b are attached to the lid 12 and adapted to engage the pawls 70a, 70b. The pair of latching fingers 82a, 82b each include a distal cam engagement surface 84a, 84b and a proximal cam engagement surface 86a, 86b, respectively. The distal cam engagement surfaces 84a, 84b engage the receiving cam engagement surfaces 76 when the lid is moved from an open position to a closed position. The camming engagement causes the pawls 70a, 70b to move apart as viewed in FIG. 3 to allow the latching fingers 82a, 82b to be engaged by the pawls 70a, 70b and the pawls 70a, 70b are biased together, as viewed in FIG. 3, to secure the lid 12 in a closed position.

The proximal cam engagement surfaces 86a, 86b are engaged with the retaining cam engagement surfaces 78 of the pawls 70a, 70b when the lid 12 is moved from the closed position to the open position. As the proximal cam engagement surfaces 36a, 36b are engaged with the retaining cam engagement surfaces 78 when the lid 12 is lifted upward, the pawls 70a, 70b are moved against the biasing force of the spring 72 to allow the retaining cam engagement surfaces 78 to move apart in FIG. 3, as viewed, and to allow the lid 12 to be opened.

As shown in FIG. 3, at least one of the pawls 70a, 70b further includes an arm 90. An inertia member 92 is pivotally mounted to the latch structure 68 below the pawls 70a, 70b. The inertia member 92 includes a finger 94 that is engageable with the arm 90 of the at least one pawl 70b. The inertia member 92 is responsive to a vertical acceleration to cause the inertia member 92 to pivot upward so that the finger 94 engages the arm 90 of the pawl 70b and to prevent the pawl 70b from moving to the unlatched position.

The above described latch assembly 50 includes a pair of pawls 70a, 70b and a pair of latching fingers 32a, 32b. However, it should be noted that any number of pawls and latching fingers including one or more can be used. In the case of one pawl 70, for example, the spring 72 can be connected to pawl and to the latch structure 68. It is further noted that the lid 12 could be used on other compartments such as a glovebox.

The latching assemblies 10, 50 keep a spring assisted armrest 12 closed due to the relative shape and interaction of a set of pawls 24a, 24b; 70a, 70b and allows the armrest 12 to be opened simply by pulling up on the armrest 12 without the need for a user actuated release button. This is only possible due to the integration of an internal inertia locking device 42, 92 to meet federal safety requirements. The sliding action of pawls that allows the ability to both latch the armrest in the closed position and unlatch the armrest to the open position, while also providing latch integrated inertia locking capability, is unique.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A vehicle compartment, comprising:
a compartment having two opposing side edges;
a lid pivotally connected along one of the two opposing side edges of the compartment;
a latch assembly disposed along a second one of the two opposing side edges and including a latch member biased by a spring toward a latched position and movable to an unlatched position;
a finger attached to the lid and adapted to engage the latch member, the finger including a first cammed engagement surface and a second cammed engagement surface and the latch member including a third cammed engagement surface and a fourth cammed engagement surface, wherein the first cammed engagement surface engages the third cammed engagement surface when the lid is moved from an open position to a closed position and the second cammed engagement surface is engaged with the fourth cammed engagement surface when the lid is moved from the closed position to the open position; and
an inertia member responsive to a vertical acceleration to prevent the latch member from moving to the unlatched position.

2. The vehicle compartment according to claim 1, wherein the compartment is a vehicle console compartment.

3. The vehicle compartment according to claim 2, wherein the lid is an armrest.

4. The vehicle compartment according to claim 1, wherein the compartment is a glove compartment.

5. The vehicle compartment according to claim 1, wherein the latch assembly includes a track slidably supporting the latch member.

6. The vehicle compartment according to claim 5, wherein the spring is disposed between the latch member and the track.

7. The vehicle compartment according to claim 5, wherein the inertia member is rotatably supported adjacent to the track.

8. The vehicle compartment according to claim 7, wherein the latch member includes a pawl that includes the third cammed engagement surface and the fourth cammed engagement surface.

9. The vehicle compartment according to claim 5, wherein when the lid is moved from the open position to the closed position, the first cammed engagement surface engages the third cammed engagement surface and causes the latch member to move against a biasing force of the spring.

10. The vehicle compartment according to claim 5, wherein when the lid is moved from the closed position to the open position, the second cammed engagement surface engages the fourth cammed engagement surface and causes the latch member to move against a biasing force of the spring.

11. A vehicle compartment, comprising:
a compartment having two opposing side edges;
a lid pivotally connected along one of the two opposing side edges of the compartment;
a latch assembly disposed along a second one of the two opposing side edges and including a pawl biased by a spring toward a latched position and movable to an unlatched position;
a finger attached to the lid and adapted to engage the pawl, the finger including a first cam engagement surface and a second cam engagement surface and the pawl including a third cam engagement surface and a fourth cam engagement surface, wherein the first cam engagement surface engages the third cam engagement surface when the lid is moved from an open position to a closed position and the second cam engagement surface is engaged with the fourth cam engagement surface when the lid is moved from the closed position to the open position; and
an inertia member responsive to a vertical acceleration to prevent the pawl from moving to the unlatched position.

12. The vehicle compartment according to claim 11, wherein the compartment is a vehicle console compartment.

13. The vehicle compartment according to claim 12, wherein the lid is an armrest.

14. The vehicle compartment according to claim 11, wherein the compartment is a glove compartment.

15. The vehicle compartment according to claim 11, wherein the latch assembly includes a support structure pivotally supporting the pawl.

16. The vehicle compartment according to claim 15, wherein the latch assembly includes two pawls pivotally supported by the support structure and the spring is disposed between the two pawls.

17. The vehicle compartment according to claim 15, wherein the inertia member is rotatably supported adjacent to the pawl.

18. The vehicle compartment according to claim 7, wherein the inertia member is rotatably supported by the support structure.

19. The vehicle compartment according to claim 15, wherein when the lid is moved from the open position to the closed position, the first cam engagement surface engages the third cam engagement surface and causes the pawl to move against a biasing force of the spring.

20. The vehicle compartment according to claim 15, wherein when the lid is moved from the closed position to the open position, the second cam engagement surface engages the fourth cam engagement surface and causes the pawl to move against a biasing force of the spring.
